(19) United States
(12) Patent Application Publication
(10) Pub. No.: US 2026/0221668 A1
(43) Pub. Date: Jul. 30, 2026

(54) RADIO WAVE REFLECTING DEVICE

(71) Applicant: Japan Display Inc., Tokyo (JP)

(72) Inventor: Takuya SHIRASAWA, Tokyo (JP)

(73) Assignee: Japan Display Inc., Tokyo (JP)

(21) Appl. No.: 19/450,789

(22) Filed: Jan. 16, 2026

(30) Foreign Application Priority Data
Jan. 27, 2025 (JP) 2025-011293

(51) Int. Cl. H01Q 15/14

(52) U.S. Cl. CPC H01Q 15/148

(57) ABSTRACT

A radio wave reflecting device includes an intelligent reflecting surface reflecting incident radio waves, a manipulator supporting the intelligent reflecting surface and carrying out an angle adjustment of the intelligent reflecting surface, an indicator indicating a reference for the angle adjustment, and a control unit configured to control the intelligent reflecting surface, the manipulator, and the indicator.

### CROSS-REFERENCE TO RELATED APPLICATION

This application claims the benefit of priority to Japanese Patent Application No. 2025-011293, filed on Jan. 27, 2025, the entire contents of which are incorporated herein by reference.

### FIELD

The present invention relates to a radio wave reflecting device for reflecting radio waves.

### BACKGROUND

In the field of communications, the introduction of the fifth generation communications standard known as 5G is progressing. 5G uses radio waves in the millimeter wave band with frequencies between 26 GHz to 29 GHz. 5G communication enables transmission over a wide bandwidth and achieves very high throughput.

Since the radio waves in the millimeter wave band frequency travel with a high degree of straightness, it is difficult for the radio waves to reach areas such as the rear side of a building. For this reason, in areas where it is difficult for radio waves to reach, a liquid crystal reflecting surface such as that disclosed in Japanese laid-open patent publication No. 2019-530387 is installed to change the transmission direction of radio waves.

According to the liquid crystal reflecting surface, since the apparent area of the liquid crystal reflecting surface changes depending on the incident angle of the incident radio wave, the strength of the reflected radio wave may change.

### SUMMARY

A radio wave reflecting device according to an embodiment of the present invention includes an intelligent reflecting surface reflecting incident radio waves, a manipulator supporting the intelligent reflecting surface and carrying out an angle adjustment of the intelligent reflecting surface, an indicator indicating a reference for the angle adjustment, and a control unit configured to control the intelligent reflecting surface, the manipulator, and the indicator.

### BRIEF DESCRIPTION OF DRAWINGS

FIG. 1 is a schematic diagram of a radio wave reflecting device according to an embodiment of the present invention.

FIG. 2 is a plan view of a liquid crystal reflecting surface according to an embodiment of the present invention.

FIG. 3 is a cross-sectional view between A-B of the liquid crystal reflecting surface shown in FIG. 2.

FIG. 4 is a plan view of a unit cell forming a liquid crystal reflecting surface.

FIG. 5 is a cross-sectional view between C-D of the unit cell shown in FIG. 4.

FIG. 6 is a schematic diagram showing how the travelling direction of scattered waves is changed by a liquid crystal reflecting surface.

FIG. 7 is a schematic diagram of a longitudinal cross-sectional view of an indicator according to an embodiment of the present invention.

FIG. 8 is a cross-sectional view along a line VIII-VIII in FIG. 7.

FIG. 9 is a diagram showing a relationship between a control unit and other elements.

FIG. 10 is a schematic diagram showing a case where a radio wave reflecting device according to an embodiment of the present invention is installed.

FIG. 11 is a schematic diagram showing the selection of hand coordinates a manipulator according to an embodiment of the present invention.

FIG. 12 is a schematic diagram of a radio wave reflecting device according to another embodiment of the present invention.

### DESCRIPTION OF EMBODIMENTS

Hereinafter, embodiments of the present invention will be described with reference to the drawings. The width, thickness, shape, and the like of each part may be schematically represented in comparison with the actual embodiments in order to clarify the description, but the drawings are merely examples and do not limit the interpretation of the present invention. In the present specification and the drawings, elements similar to those described above with respect to the previous figures are denoted by the same reference signs and detailed description thereof may be omitted as appropriate.

### Radio Wave Reflecting Device

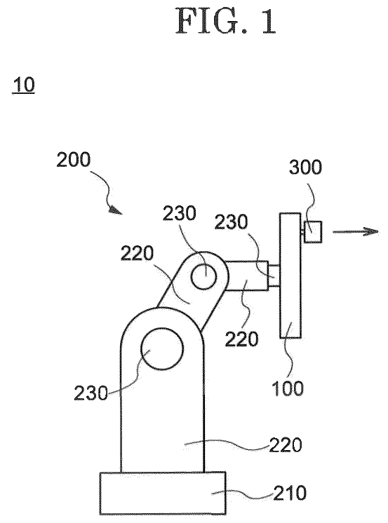

FIG. 1 is a schematic diagram of a radio wave reflecting device 10 according to an embodiment of the present invention. As shown in FIG. 1, the radio wave reflecting device 10 includes a liquid crystal reflecting surface 100, a manipulator 200, an indicator 300, and a control device 400 (not shown). In addition, the liquid crystal reflecting surface 100 may be referred to as an intelligent reflecting surface (IRS).

### Liquid Crystal Reflecting Surface

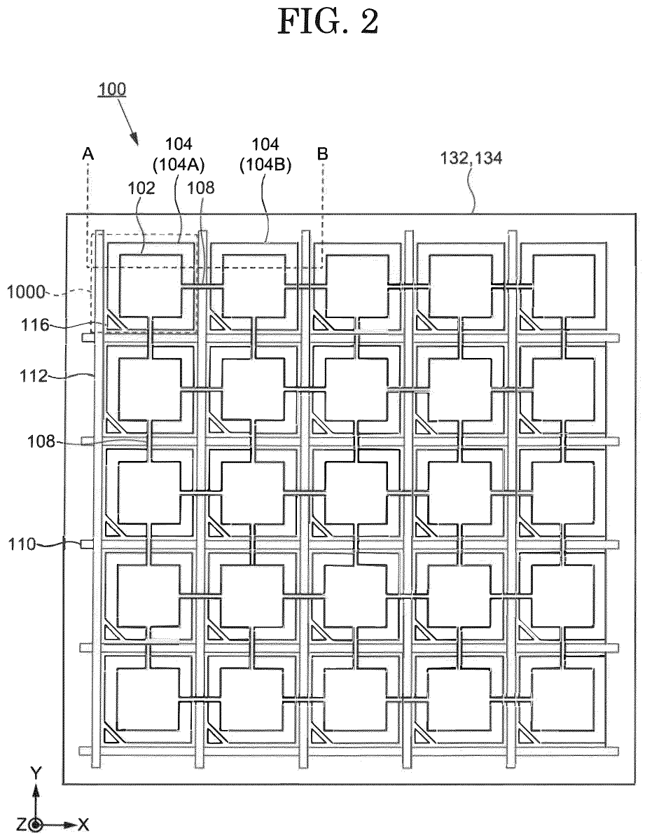

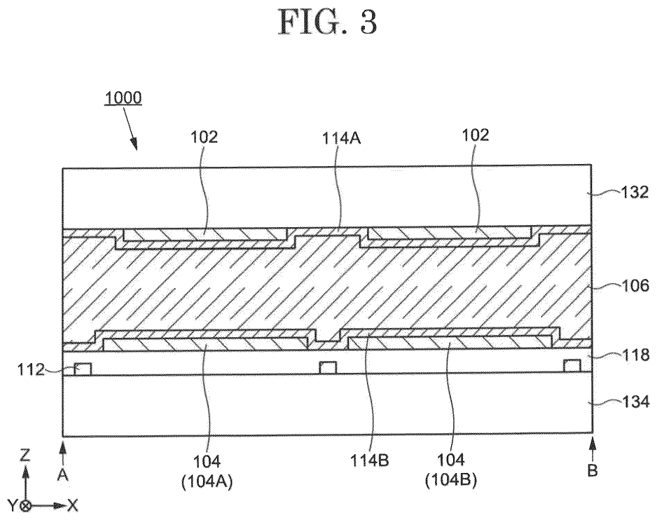

FIG. 2 is a plan view of the liquid crystal reflecting surface 100. FIG. 3 is a cross-sectional view corresponding to the section between A-B shown in FIG. 2. As shown in FIG. 2 and FIG. 3, the liquid crystal reflecting surface 100 has a plate-like shape and is formed to have a square shape in a plan view. The shape of the liquid crystal reflecting surface 100 is not limited to this, and for example, the shape may be a plate-like shape that is a rectangular shape or a circular shape in a plan view. In the case where the liquid crystal reflecting surface 100 has the plate-like shape that is the square shape in a plan view, the size of the liquid crystal reflecting surface 100 is set to, for example, 50 mm or more and 1000 mm or less on one side and 1 mm or more and 10 mm or less in thickness.

As shown in FIG. 2 and FIG. 3, the liquid crystal reflecting surface 100 includes at least one common electrode 102, at least one bias electrode 104, and a liquid crystal layer 106 disposed between the electrodes. As shown in FIG. 2, the common electrode 102 is arranged in an X-axis direction and a Y-axis direction, and the bias electrode 104 is arranged in a matrix in the X-axis direction and the Y-axis direction to correspond to the common electrode 102. Therefore, the liquid crystal reflecting surface 100 has a structure in which a plurality of common electrodes 102 and a plurality of bias electrodes 104 are arranged to form a matrix respectively. In addition, the X-axis direction and the Y-axis direction are used for explanation, and specifically indicate the direction shown in FIG. 2. The X-axis direction and the Y-axis direction can also be interpreted as one direction and a direction intersecting the one direction.

Adjacent common electrodes 102 are connected by a common wiring 108. Adjacent common electrodes 102 are not necessarily connected to each other by the common wiring 108, and may be connected only along the X-axis direction or only along the Y-axis direction. On the other hand, the bias electrode 104 is arranged so that adjacent bias electrodes have a gap therebetween, and are arranged in a physically separated state. The common electrode 102 is provided in a first substrate 132, and the bias electrode 104 is provided in a second substrate 134. The liquid crystal reflecting surface 100 is a device that scatters radio waves incident on an incident surface in a predetermined direction, and the first substrate 132 is disposed on the incident surface side and the second substrate 134 is disposed on the rear side of the incident surface. That is, the common electrode 102 is disposed on the incident surface, and the bias electrode 104 is disposed on the rear surface of the common electrode 102 with the liquid crystal layer 106 interposed therebetween.

The liquid crystal reflecting surface 100 has a structure in which the common electrode 102, the liquid crystal layer 106, and the bias electrode 104 are arranged to overlap each other in a plan view. Further, in the liquid crystal reflecting surface 100, the surface of the first substrate 132 on which the common electrode 102 is provided and the surface of the second substrate 134 on which the bias electrode 104 is provided are disposed to face each other, and the liquid crystal layer 106 is disposed therebetween. The liquid crystal reflecting surface 100 includes a stacked structure (which may also include the first substrate 132 and the second substrate 134) of a set of common electrodes 102, the liquid crystal layer 106, and the bias electrode 104 as a basic unit. Hereinafter, the basic unit is referred to as a unit cell 1000.

The second substrate 134 is provided with a selection signal line 110 extending in the X direction, a bias signal line 112 extending in the Y direction, and a switching element 116. The switching element 116 is provided to correspond to the bias electrode 104 in a one-to-one manner. A switching operation (on/off state) of the switching element 116 is controlled by a selection signal of the selection signal line 110, and a bias signal (bias voltage) is input from the bias signal line 112. The bias signal is individually input to the bias electrode 104 by the switching element 116. That is, the bias signal is individually input to the bias electrode 104 arranged in a matrix by the switching element 116.

A first alignment film 114A is provided on the first substrate 132 and a second alignment film 114B is provided on the second substrate 134. The first alignment film 114A is provided to cover the common electrode 102, and the second alignment film 114B is provided to cover the bias electrode 104. The first alignment film 114A and the second alignment film 114B are provided to control an alignment state of the liquid crystal layer 106. The liquid crystal layer 106 contains elongated rod-shaped liquid crystal molecules. An initial alignment state (an alignment state in the absence of an electric field) of the liquid crystal molecules is controlled by the first alignment film 114A and the second alignment film 114B.

The first alignment film 114A and the second alignment film 114B may have any composition as long as they have a function of aligning the liquid crystal molecules, and may be made of either an organic material or an inorganic material, for example, polyimide or the like. In addition, although an alignment direction may a horizontal alignment, vertical alignment, or a tilt alignment, the present embodiment shows the case of a horizontal alignment.

The alignment state of the liquid crystal molecules in the liquid crystal layer 106 is controlled by the bias electrode 104. Since the bias voltage applied to the bias electrode 104 can be controlled for each unit cell 1000, the alignment state of the liquid crystal molecules in the liquid crystal layer 106 can also be controlled for each unit cell 1000. The dielectric constant of the liquid crystal layer 106 changes depending on the alignment state of the liquid crystal molecules. The phase of scattered waves (also referred to as the reflected radio waves) of the liquid crystal reflecting surface 100 changes depending on the dielectric constant of the liquid crystal layer 106. Therefore, by changing the dielectric constant of the liquid crystal layer 106 for each unit cell 1000, a phase difference can be generated within the plane of the liquid crystal reflecting surface 100, and the travelling direction of the scattered wave can be controlled.

Since the liquid crystal reflecting surface 100 scatters radio waves incident on the surface on which the common electrode 102 is arranged, the common electrode 102 is also called a scatterer. In addition, the unit cell 1000 can also be regarded as a patch antenna in which a patch electrode (the common electrode 102) is provided on the upper surface of a dielectric (the liquid crystal layer 106) and a reflecting electrode (the bias electrode 104) is provided on the rear surface.

Although not shown in FIG. 2 and FIG. 3, the second substrate 134 may be provided with a drive circuit for outputting the selection signal to the selection signal line 110 and a drive circuit for outputting the bias signal to the bias signal line 112. In addition, a signal for driving the drive circuit and an input terminal for inputting a driving power may be provided.

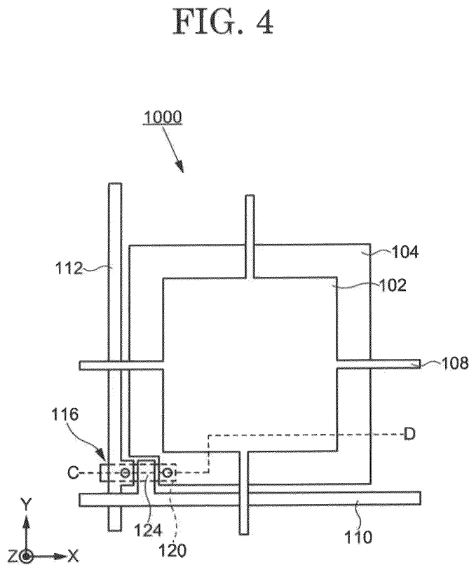

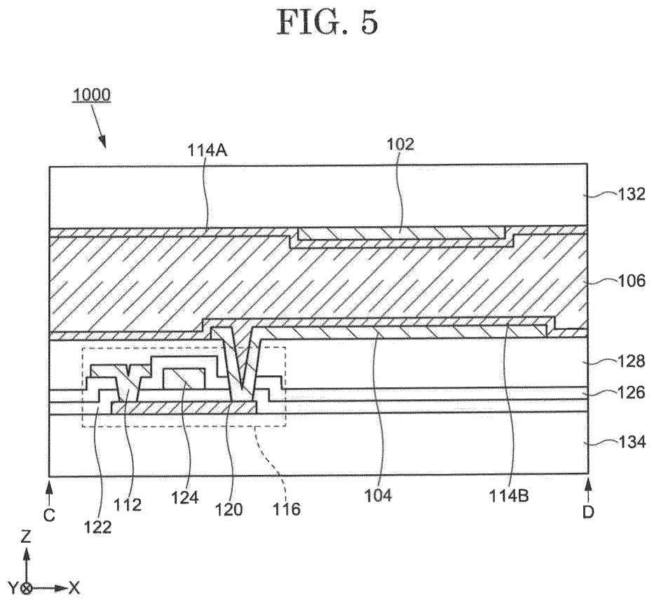

FIG. 4 and FIG. 5 show details of the unit cell 1000 forming the liquid crystal reflecting surface 100. FIG. 4 shows a plan view of the unit cell 1000, and FIG. 5 is a cross-sectional view between C-D shown in FIG. 4. As shown in FIG. 4 and FIG. 5, the unit cell 1000 is arranged so that the common electrode 102, the liquid crystal layer 106, and the bias electrode 104 overlap each other in a plan view.

The common electrode 102 used in the present embodiment has a symmetrical shape with respect to the vertical polarization and the horizontal polarization of the incident radio waves. FIG. 4 shows an example in which the common electrode 102 is square. The size (vertical and horizontal dimensions) of the common electrode 102 is appropriately set according to the frequency of the target radio wave. In addition, the shape of the common electrode 102 is not limited to a square, and may be a rectangle or may have other geometric shapes.

The common electrode 102 is connected to the common wiring 108. The common wiring 108 has a predetermined length and width. One end of the common wiring 108 is connected to a center point of one side of the common electrode 102. In other words, the common wiring 108 is connected so that the center point of one side of the common electrode 102 is included in the width portion of the common wiring 108. Although the connection structure of the common wiring 108 and the common electrode 102 is not limited, for example, the common wiring 108 and the common electrode 102 are formed in the same conductive layer. The common wiring 108 is connected to a power circuit (not shown). Alternatively, the common wiring 108 is grounded or connected to a grounded wiring. As shown in FIG. 2, the common wiring 108 connects adjacent common electrodes 102. The common electrodes 102 are connected by the common wiring 108, so that the common electrodes 102 arranged in a matrix have an equipotential.

The bias electrode 104 is formed in a large area to have a function as a reflecting surface. As shown in FIG. 4, in the unit cell 1000, the bias electrode 104 has a larger area than the common electrode 102. The bias electrode 104 and the common electrode 102 are provided to overlap, and in this case, the common electrode 102 is disposed in a region inside the bias electrode 104.

The bias electrode 104 is connected to the bias signal line 112 via the switching element 116. FIG. 4 and FIG. 5 show an example in which the switching element 116 is formed of a transistor. The transistor has a structure in which a semiconductor layer 120, a gate insulating layer 122, and a gate electrode 124 are stacked. An interlayer insulating layer 126 is provided on the gate electrode 124 and the bias signal line 112 is provided thereon. The switching element 116 and the bias signal line 112 are filled with a planarization layer 128. The bias electrode 104 is provided on the planarization layer 128. The bias electrode 104 is connected to an input/output terminal (drain) of the switching element (transistor) 116 via a contact hole. In addition, the gate electrode 124 of the switching element (transistor) 116 is connected to the selection signal line 110, and an input/output terminal (source) not connected to the bias electrode 104 is connected to the bias signal line 112.

The alignment state of the liquid crystal molecules in the liquid crystal layer 106 is controlled by the bias electrode 104. That is, the alignment state of the liquid crystal molecules in the liquid crystal layer 106 is controlled by the bias signal applied to the bias electrode 104. The bias signal is a DC voltage signal or a polarity-inverted DC voltage signal in which a positive DC voltage and a negative DC voltage are alternately inverted.

The liquid crystal layer 106 is formed of a liquid crystal material having dielectric anisotropy. For example, the liquid crystal material forming the liquid crystal layer 106 may be any material that exhibits liquid crystallinity and has dielectric anisotropy, and a nematic liquid crystal is particularly preferred. The effect of the present embodiment is unchanged regardless of whether the dielectric anisotropy of the liquid crystal material is positive or negative. Hereinafter, the present embodiment will be described with reference to the liquid crystal layer 106 having positive dielectric anisotropy.

The dielectric constant of the liquid crystal layer 106 changes depending on the alignment state of the liquid crystal molecules. The alignment state of the liquid crystal molecules is controlled by the bias electrode 104. When the incident radio wave is scattered by the unit cell 1000, the phase of the scattered wave changes depending on the dielectric constant of the liquid crystal layer.

The frequency bands reflected by the liquid crystal reflecting surface 100 are a very high frequency (VHF) band, an ultra high frequency (UHF) band, a super high frequency (SHF) band, a tremendously high frequency (THF) band, an extra high frequency (EHF) band, and a terahertz wave band. The alignment of the liquid crystal molecules in the liquid crystal layer 106 changes depending on the bias voltage applied to the bias electrode 104, but does not substantially follow the frequency of the radio wave incident on the common electrode 102. Due to such characteristics of the liquid crystal molecules, the dielectric constant of the liquid crystal layer 106 can be changed by the bias electrode 104, radio waves can bee scattered by the common electrode 102, and the phase of the scattered radio wave can be controlled.

The first substrate 132 and the second substrate 134 are provided to sandwich the liquid crystal layer 106 and form a wiring or the like, and are formed of a flat material such as glass, resin, or a metal plate. In this case, transparency is not an issue. In addition, each layer provided in the first substrate 132 and the second substrate 134 is formed using the following method. The semiconductor layer 120 is provided to form the switching element 116 and is formed of an oxide semiconductor including amorphous silicon, silicon semiconductors such as polycrystalline silicon, and metal oxides such as indium oxide, zinc oxide, gallium oxide, and the like. The gate insulating layer 122 and the interlayer insulating layer 126 are provided to insulate each wiring layer, and therefore may be made of any insulating material, such as a silicon oxide film, a silicon nitride film, or a stacked structure thereof. The selection signal line 110 and the gate electrode 124 are provided to transmit an electrical signal, and are preferably made of a conductive material, such as a metal film. For example, the selection signal line 110 and the gate electrode 124 are made of molybdenum (Mo), tungsten (W), or an alloy thereof. The bias signal line 112 is provided to transmit an electrical signal, and is preferably made of a conductive material, such as a metal film. For example, the bias signal line 112 is made of a stacked structure of titanium (Ti)/aluminum (Al) titanium (Ti), or a stacked structure of molybdenum (Mo)/aluminum (Al)/molybdenum (Mo). The planarization layer 128 is formed to planarize irregularities and the like formed by switching elements and the like. Any material having flatness and insulating properties may be used, for example, an organic material is desirable, and an acrylic resin, an epoxy resin, a polyimide material, or the like can be used. The common electrode 102, the bias electrode 104, and the common wiring 108 have a function of conducting a signal for driving a liquid crystal and a function of scattering an input radio wave. Both may be conductive, and a metal film or the like may be used. Particularly, a material with low conductivity is desirable, and for example, aluminum, copper, gold, or an alloy using the same can be used. Further, in order to reduce the resistance, it is desirable to make the thickness of the common electrode 102, the bias electrode 104, and the common wiring 108 thicker than that of the bias signal line and the selection signal line.

In addition, although not shown in FIG. 5, the first substrate 132 and the second substrate 134 are disposed to have a gap therebetween, and are bonded together with a sealing material. The sealing material only needs to have a function of bonding the first substrate 132 and the second substrate 134 together, and is formed of an organic material such as an acryl resin or an epoxy resin. The liquid crystal layer 106 is sealed in a region surrounded by the first substrate 132, the second substrate 134, and the sealing material. The gap between the first substrate 132 and the second substrate 134 is approximately 20 μm to 100 μm, for example, 40 μm. Although not shown, a spacer may be provided between the first substrate 132 and the second substrate 134 to keep the gap constant.

As shown in FIG. 4, the common electrodes 102 arranged in a matrix are connected by the common wiring 108, and the bias electrode 104 is connected to the bias signal line 112 via the switching element 116 so that the potential can be individually controlled, whereby the dielectric constant of the liquid crystal layer 106 can be changed for each unit cell 1000. As a result, the phase of the scattered wave can be controlled for each unit cell 1000.

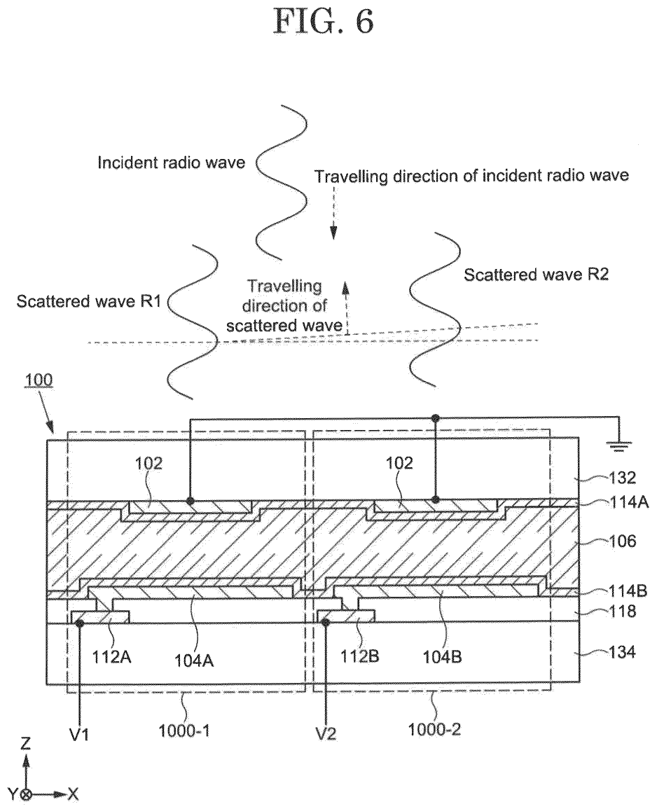

FIG. 6 schematically shows an embodiment in which the travelling direction the scattered wave is changed by a first unit cell 1000-1 and a second unit cell 1000-2. A bias signal V1 is applied from a bias signal line 112A to a bias electrode 104A of the first unit cell 1000-1, and a bias signal V2 is applied from a bias signal line 112B to a bias electrode 104B of the second unit cell 1000-2. In this case, the bias signal V1 and the bias signal V2 have different voltage levels (V1≠V2). The common electrodes 102 of the first unit cell 1000-1 and the second unit cell 1000-2 have the same potential, and are set to, for example, a common potential.

FIG. 6 schematically shows that, when the radio wave is incident on the first unit cell 1000-1 and the second unit cell 1000-2 in the same phase, since different control signals (V1≠V2) are applied to the first unit cell 1000-1 and the second unit cell 1000-2, the phase change of the scattered wave due to the second unit cell 1000-2 is larger than that of the first unit cell 1000-1. As a result, the phase of the scattered wave R1 scattered by the first unit cell 1000-1 is different from the phase of the scattered wave R2 scattered by the second unit cell 1000-2 (in FIG. 6, the phase of the scattered wave R2 is advanced from the phase of the scattered wave R1), and apparently, the travelling direction of the scattered wave changes in an oblique direction.

As shown in FIG. 6, the liquid crystal reflecting surface 100 can cause the phase of the scattered wave of the incident radio wave to differ between the first unit cell 1000-1 and the second unit cell 1000-2. FIG. 6 schematically shows two unit cells 1000, but in practice, by individually controlling the unit cell 1000 arranged in a matrix, the travelling direction of the scattered wave can be controlled in any direction without changing the direction of the liquid crystal reflecting surface 100. Since the plurality of common electrodes 102 arranged on the reflecting surface of the liquid crystal reflecting surface 100 is held at a constant potential (for example, a ground potential), the bias electrodes 104A and 104B and the bias signal lines 112A and 112B for applying the bias voltage to the liquid crystal layer 106 are arranged on the rear surface of the common electrode 102, it is possible to prevent the front surface of the liquid crystal reflecting surface 100 from being affected by the electric field generated by the bias signal lines 112A and 112B.

### Manipulator

The manipulator 200 supports the liquid crystal reflecting surface 100 and carries out the angle adjustment of the liquid crystal reflecting surface 100. As shown in FIG. 1, the manipulator 200 includes a base 210, a plurality of links 220, and a plurality of joints 230 connecting the links 220 and 220. The manipulator 200 can adjust not only the angle of the liquid crystal reflecting surface 100 with respect to the base 210 but also the position of the liquid crystal reflecting surface 100 with respect to the base 210. Examples of the manipulator 200 include a vertical articulated robot, a scalar robot, a parallel ring robot, and an orthogonal robot. The manipulator 200 is preferably the vertically articulated robot from the viewpoint of accurately adjusting the angle of the liquid crystal reflecting surface 100. The manipulator 200 may include a rotating portion that rotates the liquid crystal reflecting surface 100 around an axis perpendicular to the liquid crystal reflecting surface 100, or a movable portion such as a linear actuator that linearly moves the liquid crystal reflecting surface 100 in a direction perpendicular to the liquid crystal reflecting surface 100.

### Indicator

The indicator 300 provides the user with a reference for the angle adjustment of the liquid crystal reflecting surface 100. The indicator 300 is disposed on the surface of the liquid crystal reflecting surface 100 as shown in FIG. 1, but the location of the arrangement is not limited to this. According to the radio wave reflecting device 10, the user can easily adjust the reflected radio waves using the manipulator 200 while checking the reference indicated by the indicator 300.

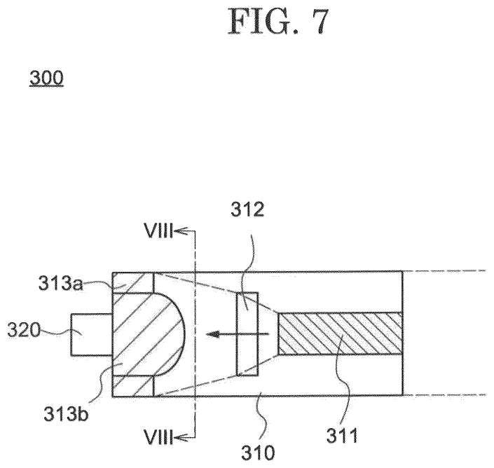

FIG. 7 is a schematic diagram in a cross-sectional view when the indicator 300 is cut along the longitudinal direction. As shown in FIG. 7, the indicator 300 includes a cylindrical body 310 and an indicator drive unit 320 disposed outside the body 310. In addition, the indicator 300 includes an LED laser 311 disposed on one end side of the body 310 inside the body 310, a beam expander 312 that expands the laser beam emitted from the LED laser 311, and a mirror member 313 disposed on the other end side of the body 310 and reflecting the expanded laser beam from the LED laser 311. The mirror member 313 includes a mirror surface 313a and a mirror ball 313b that is disposed to penetrate the center of the mirror surface 313a. The mirror ball 313b is disposed inside the body 310 to rotate around the central axis of the body 310.

The LED laser 311, the beam expander 312, and the mirror ball 313b are each connected to the indicator drive unit 320 and driven by the indicator drive unit 320. In addition, the angle of the indicator 300 with respect to the liquid crystal reflecting surface 100 is adjusted by the indicator drive unit 320. The laser beam emitted from the LED laser 311 is reflected by the mirror member 313 via the beam expander 312, and is emitted from one end of the body 310.

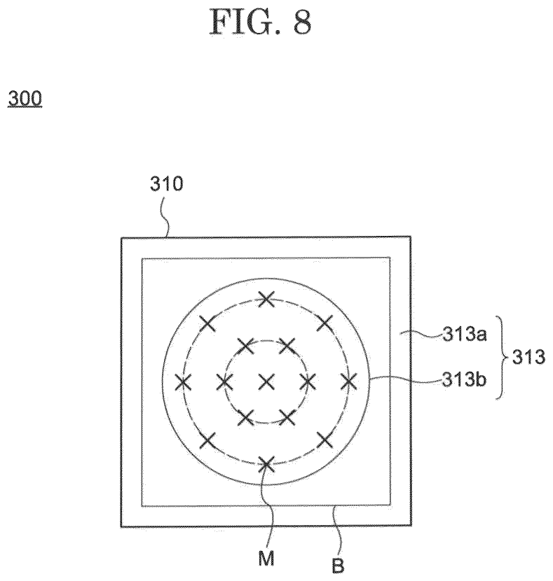

FIG. 8 is a cross-sectional view of the body 310 along VIII-VIII in FIG. 7. As shown in FIG. 8, a square-shaped boundary B is formed on the surface of the mirror surface 313a to coincide with a range that the reflected radio waves reach when the laser beam is projected onto a wall or the like. The shape of the boundary B is not limited to this. A plurality of X-shaped marks M is formed on the surface of the mirror ball 313b. The shape of the mark M is not limited to this. In addition, the mark M forms a pattern that is point-symmetric on the circumference of a plurality of circles centered on the center of the mirror ball 313b. The pattern of the mark M is not limited to this.

The laser beam emitted from one end of the indicator 300 is projected onto a wall or the like, so that the user can recognize the reference for adjusting the angle of the liquid crystal reflecting surface 100. In addition, from the projected boundary B, it is possible to recognize a range in which the reflected radio waves reach. Further, as the indicator 300 moves straight and the mirror ball 313b rotates, the projected mark M also moves, so that the center of the boundary B can be easily recognized.

### Control Device

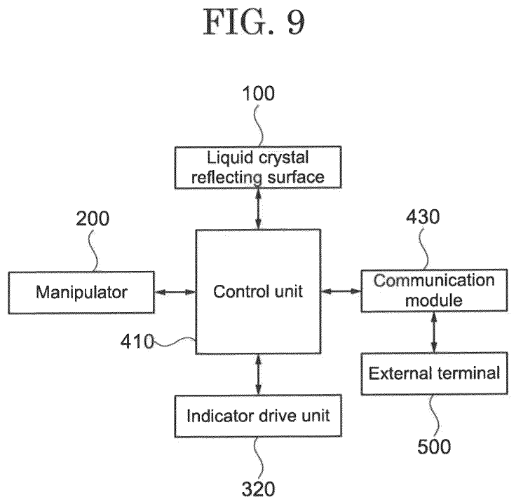

The control device 400 includes a control unit 410, a storage unit 420 (not shown), and a communication module 430. The control unit 410 is configured to control the liquid crystal reflecting surface 100, the manipulator 200, and the indicator drive unit 320. FIG. 9 is a block diagram showing a relationship between the control unit 410 and other elements. As shown in FIG. 9, the control unit 410 is electrically connected to the liquid crystal reflecting surface 100, the manipulator 200, and the indicator drive unit 320. In addition, the control unit 410 is connected to an external terminal 500 via the communication module 430. The storage unit 420 (not shown) stores a control program of the control unit 410, information on the angle of the liquid crystal reflecting surface 100, information on the direction in which the laser beam from the indicator 300 points, and the like.

A command input by the user from the external terminal 500 is input to the control unit 410 via the communication module 430. The control unit 410 controls the liquid crystal reflecting surface 100, the manipulator 200, and the indicator drive unit 320 based on the control program according to the input command.

### Method for Driving Radio Wave Reflecting Device

### Initial Setting

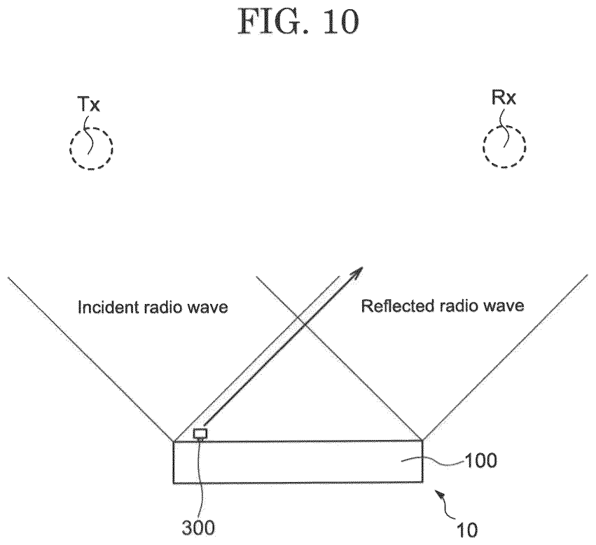

FIG. 10 is a schematic view when the radio wave reflecting device 10 is installed. As shown in FIG. 10, radio waves are emitted from a wave source Tx such as a base station, and the radio waves are incident on the radio wave reflecting device 10. The phase of the radio wave incident on the radio wave reflecting device 10 is changed by the liquid crystal reflecting surface 100, and the radio waves are reflected toward the receiving area Rx. In addition, a laser beam is emitted from the indicator 300 toward the receiving area Rx. In the receiving area Rx, the user operates the external terminal 500 to drive the manipulator 200 to adjust the angle of the liquid crystal reflecting surface 100 so that the strength of the reflected radio wave received by the external terminal 500 is maximized, thereby determining the angle of the liquid crystal reflecting surface 100. Next, in the state where the angle of the liquid crystal reflecting surface 100 is fixed, the user operates the external terminal 500 to drive the liquid crystal reflecting surface 100 (to change the phase of the incident radio waves) to adjust the reflection angle of the reflected radio wave with respect to the liquid crystal reflecting surface 100 so that the strength of the received reflected radio wave is maximized, thereby determining the reflection angle of the reflected radio wave.

### Auto Setting

### For Single User

The user operates the external terminal 500 to set it to the reception strength optimization mode. The control unit 410 repeats fine adjustment of the angle of the liquid crystal reflecting surface 100 by driving the manipulator 200 and fine adjustment of the reflection angle of the reflected radio wave by driving the liquid crystal reflecting surface 100 so that the strength of the reflected radio wave received by the user is maximized or is a certain threshold or more. In the case where the angle of the liquid crystal reflecting surface 100 at which the strength of the reflected radio wave is maximized and the reflection angle of the reflected radio wave has a certain range, the control unit 410 uses the center value of the range as the angle of the liquid crystal reflecting surface 100 and the reflection angle of the reflected radio wave. When the angle of the liquid crystal reflecting surface 100 and the reflection angle of the reflected radio wave at which the strength of the reflected radio wave is maximized are set, the control unit 410 informs the user by, for example, flashing the pattern of the indicator 300.

Specifically, in the case where a hand coordinate X of the manipulator 200 is expressed as the coordinates of the center at the coupling portion between the liquid crystal reflecting surface 100 and the joint 230 (three-dimensional), the direction of the perpendicular line extending from the center to the liquid crystal reflecting surface 100 (two-dimensional), and the rotation angle of the liquid crystal reflecting surface 100 around the perpendicular line as the rotation axis (one-dimensional), as shown in the following Expression (1), the hand coordinate X is changed slightly, and each time the hand coordinate X is changed, the user receives the reflected radio wave over the entire range of the reflection angle θ of the reflected radio wave. This makes it possible to determine the hand coordinate X at which the strength of the received reflected radio wave is maximized or is a certain threshold or more.

[Expression 1]

X: Hand coordinates (X∈R\hat{ }6, 3D coordinates×2-dimensional direction×1-dimensional rotation) (1)

When there are multiple hand coordinates X where the strength of the reflected radio wave to be received is maximized or is a certain threshold or more, and a hand coordinate set Y is determined according to the following Expression (2), a hand coordinate Xopt is selected using the median value of the hand coordinate set Y as the optimum value according to the following Expression (3). Then, at the selected hand coordinate Xopt, the user receives the reflected radio waves again over the entire range of the reflection angle θ of the reflected radio wave, and the reflection angle θ at which the strength of the reflected radio wave is maximized or the median value thereof is determined.

[Expression 2]

Y={x∈X|P(x, θ)>Ps for a Certain Reflection Angle θ} (2)

In this case, P is the strength of the received reflected radio wave, and Ps is the maximum value or a certain threshold of the strength of the reflected radio wave.

[Expression 3]

Xopt=Median (Y) (3)

### For Multiple Users

The user operates the external terminal 500 to set it to the reception strength optimization mode. The control unit 410 repeats fine adjustment of the angle of the liquid crystal reflecting surface 100 by driving the manipulator 200 and fine adjustment of the reflection angle of the reflected radio wave by driving the liquid crystal reflecting surface 100 so that the strength of the received reflected radio wave is higher than a certain threshold for a certain user. Next, within the range of the angle of the liquid crystal reflecting surface 100 and the reflection angle of the reflected radio wave where the strength of the reflected radio wave received by a certain user is higher than a certain threshold, the control unit 410 repeats fine adjustment of the angle of the liquid crystal reflecting surface 100 by driving the manipulator 200 and fine adjustment of the reflection angle of the reflected radio wave by driving the liquid crystal reflecting surface 100 so that the strength of the reflected radio wave received by the other user is higher than a certain threshold. The control unit 410 repeats these steps as many times as the number of users. In the case where the angle of the liquid crystal reflecting surface 100 and the reflection angle of the reflected radio wave have a certain range at which the strength of the received reflected radio wave is higher than a certain threshold received for all users, the control unit 410 uses the central value of the range as the angle of the liquid crystal reflecting surface 100 and the reflection angle of the reflected radio wave. When the angle of the liquid crystal reflecting surface 100 and the reflection angle of the reflected radio wave at which the strength of the received reflected radio wave is higher than a certain threshold for all users are set for all users, the control unit 410 informs the user via the indicator 300.

Specifically, in the case where the hand coordinate X of the manipulator 200 is expressed as the coordinates of the center at the coupling portion between the liquid crystal reflecting surface 100 and the joint 230 (three-dimensional), the direction of the perpendicular line extending from the center to the liquid crystal reflecting surface 100 (two-dimensional), and the rotation angle of the liquid crystal reflecting surface 100 around the perpendicular line as the rotation axis (one-dimensional), as shown in the above Expression (1), the hand coordinate X is changed slightly, and each time the hand coordinate X is changed, the plurality of users each receive the reflected radio wave over the entire range of the reflection angle θ of the reflected radio wave. This makes it possible to determine the hand coordinate X at which the strength of the received reflected radio wave is maximized or is a certain threshold or more for the plurality of users.

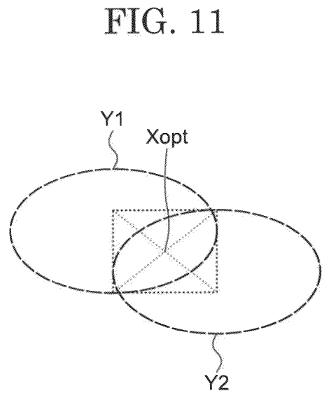

For a certain user and another user, there are a plurality of hand coordinates X at which the strength of the received reflected radio wave is maximized or is a certain threshold or more, and when the hand coordinate set Y is determined according to the following Expression (4), the hand coordinate Xopt is selected using the median value of the hand coordinate set Y as the optimum value according to the above Expression (3). As shown in FIG. 11, the hand coordinate Xopt between a certain user and another user is selected as the center of the portion where a hand coordinate set Y1 of one user and a hand coordinate set Y2 of another user overlap. Then, in the selected hand coordinate Xopt, a certain user and another user receive the reflected radio waves again over the entire range of the reflection angle θ of the reflected radio wave respectively and determine the reflection angle θ at which the strength of the reflected radio wave is maximized or the median value thereof.

[Expression 4]

Y={x∈X|P1(x, θ)>Ps and P2(x, θ)>Ps for a certain reflection angle θ} (4)

In this case, P1 is the strength of the reflected radio wave received by a certain user, P2 is the strength of the reflected radio wave received by another user, and Ps is the maximum value or a certain threshold of the strength of the reflected radio wave.

### Manual Setting

### When the Liquid Crystal Reflecting Surface 100, the Manipulator 200, and the Indicator 300 are not Linked

The user operates the external terminal 500 to adjust the laser beam from the indicator 300 to a position where the reflected radio wave is desired to reach (a position where the reception strength of the reflected radio wave is maximized). The user stores the position information indicated by the laser beam from the indicator 300 in the storage unit 420 via the external terminal 500. The user causes the control unit 410 via the external terminal 500 to adjust the angle of the liquid crystal reflecting surface 100 by driving the manipulator 200 and the reflection angle of the reflected radio wave by driving the liquid crystal reflecting surface 100 so that the reflected radio wave reaches the position indicated by the laser beam based on the stored position information. This allows the user to make the reflected radio wave reach a desired position.

### When the Liquid Crystal Reflecting Surface 100, the Manipulator 200, and the Indicator 300 are Linked

The user operates the external terminal 500 to adjust the laser beam from the indicator 300 to a position where the reflected radio wave is desired to reach (a position where the reception strength of the reflected radio wave is maximized). The control unit 410 drives the liquid crystal reflecting surface 100, the manipulator 200, and the indicator drive unit 320 in conjunction with each other so that the direction indicated by the laser beam from the indicator 300 coincides with the direction of the reflected radio wave (the direction that maximizes the reception strength of the reflected radio wave). This allows the user to make the reflected radio waves reach the desired position while checking the laser light from the indicator 300.

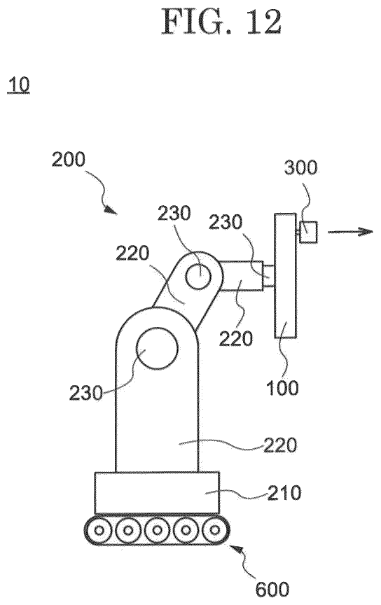

Although the radio wave reflecting device 10 according to the first embodiment of the present invention has been described, the specific aspect of the present invention is not limited to the above embodiment. For example, as shown in FIG. 12, the radio wave reflecting device 10 may include a moving mechanism 600 that is disposed below the base 210 of the manipulator 200 and moves the radio wave reflecting device 10.

Further, it is understood that, even if the effect is different from those provided by each of the above embodiments, the effect obvious from the description in the specification or easily predicted by persons ordinarily skilled in the art is apparently derived from the present invention.

What is claimed is:

1. A radio wave reflecting device comprising:
an intelligent reflecting surface reflecting incident radio waves;
a manipulator supporting the intelligent reflecting surface and carrying out an angle adjustment of the intelligent reflecting surface;
an indicator indicating a reference for the angle adjustment; and
a control unit configured to control the intelligent reflecting surface, the manipulator, and the indicator.

2. The radio wave reflecting device according to claim 1, wherein
the indicator includes a cylindrical body, an LED laser disposed inside the body, a beam expander disposed inside the body and expanding a laser beam emitted from the LED laser, and a mirror member reflecting the expanded laser beam.

3. The radio wave reflecting device according to claim 2, wherein
the indicator is disposed on the intelligent reflecting surface, and the control unit is configured to control the intelligent reflecting surface, the manipulator, and the indicator so that a direction of a laser beam emitted from the indicator coincides with a direction of radio waves reflected by the intelligent reflecting surface.

4. The radio wave reflecting device according to claim 3, further comprising:
a communication module; and
an external terminal connected to the control unit via the communication module.
